(19) United States
(12) Patent Application Publication
(10) Pub. No.: US 2026/0051711 A1
(43) Pub. Date: Feb. 19, 2026

(54) Systems, Methods, And Devices For Gas Pressure Profile Control

(71) Applicant: EUV Tech, Inc., Martinez, CA (US)

(72) Inventor: Seth Cousin, Fairfield, CA (US)

(73) Assignee: EUV Tech, Inc., Martinez, CA (US)

(21) Appl. No.: 18/806,397

(22) Filed: Aug. 15, 2024

(51) Int. Cl. H01S 3/036; H01S 3/0943

(52) U.S. Cl. CPC H01S 3/036; H01S 3/0943

(57) ABSTRACT

Systems, methods, and devices disclosed herein provide gas pressure profile control for optical output generation. Systems include a light source configured to generate laser light, and a gas pressure profile controller. The gas pressure profile controller includes a first housing portion, a second housing portion coupled to the first housing portion, wherein the first housing portion and the second housing portion include an internal chamber, wherein the internal chamber includes an interaction region. The gas pressure profile controller includes a first optical path configured to receive the laser light, and a second optical path configured to transmit an optical output generated, at least in part, based on an interaction between the laser light and a gas, the second optical path being further configured to constrict a flow of gas from the interaction region. Systems include a gas source configured to provide a gas to the gas pressure profile controller.

### FIELD OF TECHNOLOGY

This patent application relates generally to optical output generation, and more specifically to gas profile control used in such optical output generation.

### BACKGROUND

The generation and usage of optical outputs may be applied in a variety of contexts, such as that of a semiconductor manufacturing process. For example, such optical outputs may be used for imaging, measurement, and defect detection in optical masks used for lithography and etching of materials, such as silicon wafers. However, conventional techniques for generating such optical outputs remain limited because they are not able to effectively and efficiently generate light used for such optical outputs.

### SUMMARY

In some embodiments, systems include a light source configured to generate laser light, and a gas pressure profile controller that includes a first housing portion and a second housing portion coupled to the first housing portion, wherein the first housing portion and the second housing portion include an internal chamber, wherein the internal chamber includes an interaction region. The gas pressure profile controller also includes a first optical path configured to receive the laser light, and a second optical path configured to transmit an optical output generated, at least in part, based on an interaction between the laser light and a gas, the second optical path being further configured to constrict a flow of gas from the interaction region. Systems further include a gas source configured to provide a gas to the gas pressure profile controller.

In various embodiments, the optical output is generated via high harmonic generation of light based on an interaction between the laser light and the gas within the interaction region. In various embodiments, the optical output includes extreme ultraviolet light. According to some embodiments, the first housing portion and the second housing portion have conical geometries. In some embodiments, the first housing portion and the second housing portion are generated via a three-dimensional additive manufacturing process. In various embodiments, the second optical path has an aperture that is less than 50 micrometers. According to some embodiments, systems also include a light controller configured to focus the laser light to the first optical path. In some embodiments, a width of the interaction region is adjustable. In various embodiments, the width of the interaction region is dynamically adjustable in response to a user input.

In various embodiments, devices include a first housing portion including a first portion of an internal chamber configured to receive gas from a gas source, and a second housing portion coupled to the first housing portion wherein the first housing portion and the second housing portion include an internal chamber configured to receive gas from a gas source, wherein the internal chamber includes an interaction region. Devices may also include a first optical path configured to receive laser light from a light source and further configured to constrict a flow of gas from the interaction region, and a second optical path configured to transmit an optical output generated based, at least in part, on an interaction between the laser light and a gas, the second optical path being further configured to constrict a flow of gas from the interaction region.

In some embodiments, the optical output is generated via high harmonic generation of light based on an interaction between the laser light and the gas within the interaction region. In various embodiments, the optical output includes extreme ultraviolet light. According to some embodiments, the first housing portion and the second housing portion have conical geometries. In some embodiments, the first housing portion and the second housing portion are generated via a three-dimensional additive manufacturing process. In various embodiments, a width of the interaction region is adjustable.

In some embodiments, methods include establishing a designated gas pressure profile within an interaction region of a gas pressure profile controller, the gas pressure profile controller comprising a first housing portion and a second housing portion coupled to the first housing portion via the interaction region, and providing light from a light source to the interaction region via a first optical path. Methods also include generating an optical output via a second optical path and based, at least in part, on an interaction between a gas within the interaction region and the light, and maintaining the designated gas pressure profile during the generating of the optical output.

In some embodiments, the optical output is generated via high harmonic generation of light based on the interaction between the light and the gas within the interaction region. In various embodiments, the first housing portion and the second housing portion have conical geometries. According to some embodiments, the first housing portion and the second housing portion are generated via a three-dimensional additive manufacturing process. In some embodiments, the second optical path has an aperture that is less than 50 micrometers.

These and other embodiments are described further below with reference to the figures.

### BRIEF DESCRIPTION OF THE DRAWINGS

The included drawings are for illustrative purposes and serve only to provide examples of possible structures and operations for the disclosed inventive systems, apparatus, methods, and devices for gas pressure profile control. These drawings in no way limit any changes in form and detail that may be made by one skilled in the art without departing from the spirit and scope of the disclosed implementations.

FIG. 1 illustrates an example of a system for gas pressure profile control, configured in accordance with some embodiments.

FIG. 2 illustrates an example of a device for gas pressure profile control, configured in accordance with some embodiments.

FIG. 3 illustrates another example of a device for gas pressure profile control, configured in accordance with some embodiments.

FIG. 4 illustrates an example of a method for gas pressure profile control, performed in accordance with some embodiments.

FIG. 5 illustrates another example of a method for gas pressure profile control, performed in accordance with some embodiments.

FIG. 6 illustrates an example of an additional method for gas pressure profile controller fabrication, performed in accordance with some embodiments.

FIG. 7 illustrates an example of a diagram of gas pressure profiles, configured in accordance with some embodiments.

### DETAILED DESCRIPTION

Optical outputs may be used in a variety of contexts within a semiconductor manufacturing process. More specifically, such optical outputs may include extreme ultraviolet (EUV) light which may be used for various measurement and diagnostic purposes. In one example, EUV light may be used for imaging and measuring of optical masks that May subsequently be used for etching of a target material, such as a silicon substrate. However, conventional techniques for generating optical outputs may be limited in their ability to efficiently generate an optical output. More specifically, gases used in the generation of the optical output may also result in reabsorption of the generated optical output, thus reducing an overall optical output and efficiency of the generation of such optical output. For example, conventional systems and devices may be manufactured using techniques such as CNC machining and EDM processes that are not able to consistently and reliably achieve precise manufacturing of features approximately 100 micrometers. Accordingly, due to the relatively large size of such features, such conventional systems and devices experience gas leakage from an execution gas, and the leaked gas reabsorbs generated light and reduces an overall efficiency of the generation of the optical output.

Embodiments disclosed herein provide gas profile control throughout systems and devices used to generate optical outputs thus enabling efficient generation of an optical output, while also reducing reabsorption of the generated optical output by ambient gases. As will be discussed in greater detail below, techniques disclosed herein provide gas flow constriction control that provides a high gas pressure region for light generation, and a quasi-instantaneous drop in pressure to a low gas pressure region that reduces reabsorption that may otherwise occur as the light travels to a target. Gas flow constriction control May be provided by a pressure profile controller having a high aspect ratio configured to implement optical transmission as well as gas flow constriction thus achieving the above-described pressure boundary.

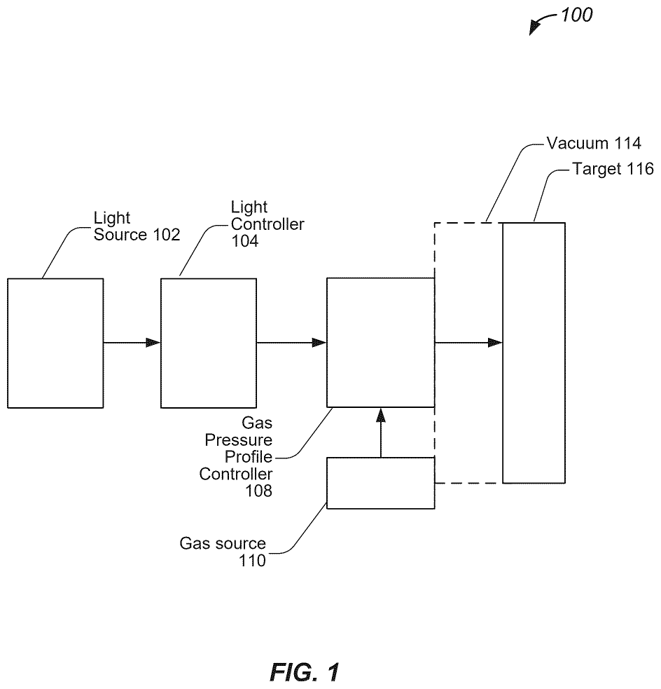

FIG. 1 illustrates an example of a system for gas pressure profile control, configured in accordance with some embodiments. As similarly discussed above, a gas pressure profile may be controlled during generation of an optical output via one or more techniques, such as excitation of a gas. Accordingly, a system, such as system 100, may be configured to include a pressure profile controller that is configured to maintain a high-pressure gradient used for the generation of a optical output.

In various embodiments, system 100 includes light source 102 which is configured to generate an optical output used to provide excitation to gases that generate the optical output when excited. In one example, light source 102 may be a laser light source that is configured to produce a collimated optical output. The output of light source 102 may be provided to light controller 104 which may be configured to provide optical guidance for the output of light source 102. For example, light controller 104 may include a waveguide or one or more other focusing elements configured to focus and guide an output of light source 102 to gas pressure profile controller 108.

System 100 further includes gas pressure profile controller 108 which is configured to control a flow of gas into a region that interacts with the output of light source 102 and light controller 104. Accordingly, gas pressure profile controller 108 may receive a gas from gas source 110, and the gas may be pressurized to a target operational pressure. As will be discussed in greater detail below, in response to being exposed to the optical output in the interaction region, the gas may be excited, and emit a optical output. In one example, the gas may experience high-harmonic generation of light in which the excited gas emits high harmonics of the received laser light. In various embodiments, the output of gas pressure 18 profile controller 108 may be extreme ultraviolet light. For example, the generated output may have a wavelength of 13.5 nm.

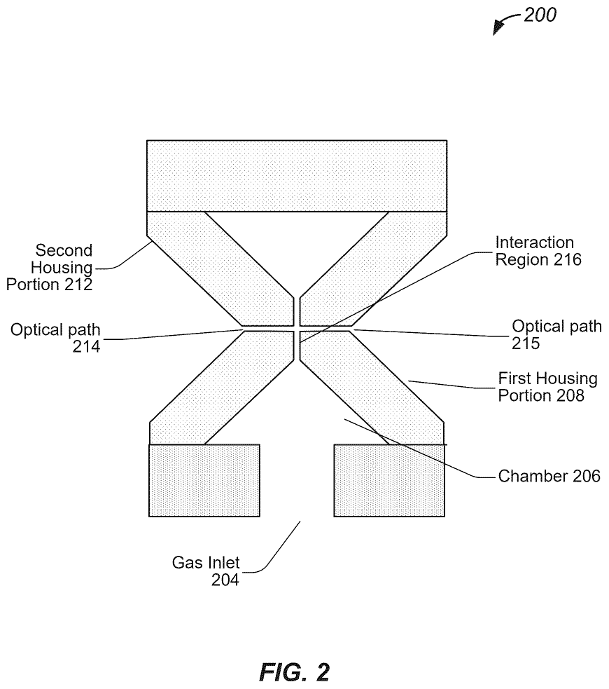

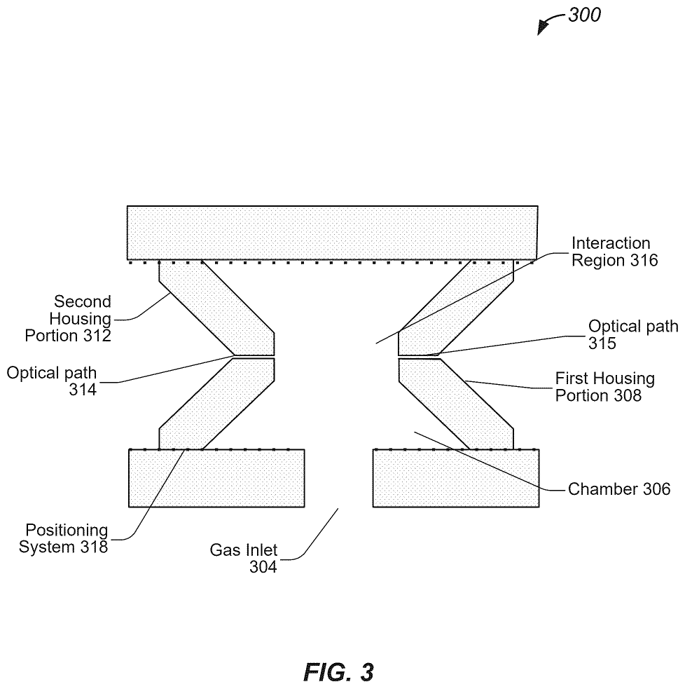

As will be discussed in greater detail below, gas pressure profile controller 108 may be configured to have a relatively high aspect ratio that is configured to maintain a gradient between a high pressure region used for generation of an optical output, and a low pressure region having near-vacuum conditions to reduce reabsorption of the generated optical output by ambient gas that would otherwise be present. In various embodiments, gas pressure profile controller 108 is configured to have an optical pathway small enough to substantially prevent the flow of gas from the interaction region to vacuum 114. In this way, gas pressure profile controller 108 is configured to provide a quasi-instantaneous drop in pressure from the interaction region to vacuum 114, and is configured to reduce optical output loss that would otherwise occur due to reabsorption. Additional details regarding gas pressure profile controller 108 are discussed in greater detail below with reference to at least FIG. 2 and FIG. 3. In various embodiments, a vacuum may also be maintained between light source 102, light controller 104, and gas pressure profile controller 108. In this way, a vacuum may be maintained before and after gas pressure profile controller 108 along the optical axis and pathway. In some embodiments, maintaining a vacuum prior to the gas pressure profile controller 108 improves the efficacy of light focusing and other light control operations that may occur prior to light being provided to gas pressure profile controller 108.

System 100 may further include target 116, and may also be configured to maintain vacuum 114 between gas pressure profile controller 108 and target 116. Accordingly, a optical output of gas pressure profile controller 108 may be projected towards target 116 for one or more diagnostic and/or imaging operations. As similarly discussed above, target 116 may be an object undergoing a manufacturing process, such as a silicon wafer undergoing photolithography. Accordingly, target 116 may have an optical mask deposited upon it, and the optical output may be used to illuminate the optical mask for defect detection operations. In some embodiments, target 116 as well as system 100 may be implemented in one or more other operational contexts, such as extreme ultraviolet-based spectroscopy or microscopy.

FIG. 2 illustrates an example of a device for gas pressure profile control, configured in accordance with some embodiments. As similarly discussed above, a gas pressure profile controller may be used to control a gas pressure profile during generation of an optical output via one or more techniques, such as excitation of a gas. Accordingly, a device, such as device 200, may be configured to implement such gas pressure profile control, thus maintaining a high-pressure gradient used for the generation of a optical output.

In various embodiments, FIG. 2 illustrates a cross-section of device 200. For example, device 200 may have a cylindrical geometry with conical portions defining an internal chamber, such as chamber 206. More specifically, first housing portion 208 may be a first conical section having a first aspect ratio. Moreover, second housing portion 212 may be a second conical section having a second aspect ratio, and may define second chamber portion 210.

In various embodiments, chamber 206 may be coupled to gas inlet 204, and may be configured to receive a gas from a gas source, as similarly discussed above. Accordingly, a gas that may undergo optically induced excitation may be pumped into chamber 206 via gas inlet 204, and chamber 206 may be pressurized to a target pressure. Moreover, the gas May pass through interaction region 216, that includes optical path 214 and optical path 215, where it is exposed to light from a light source, and may undergo excitation and generation of an optical output. As discussed above, such a process may be high harmonic generation of an optical output. Thus, an optical input, which may be laser light, may be received via optical path 214, and an output may be generated and provided via optical path 215.

In various embodiments, a size of optical path 214 and optical path 215 is configured to be small enough to prevent a substantial flow of gas from interaction region 216 to an exterior vacuum. More specifically, an optical path through device 200 may be configured to be small enough to prevent significant flow of gas from within a pressurized portion of an internal chamber of device 200 to an external vacuum that may be maintained between device 200 and a target. In this way, a pressure profile may be maintained within device 200, and leakage of gas to an external vacuum may be prevented. Such prevention of the leakage of gas from within device 200 prevents gas from reabsorbing the generated optical output as would otherwise occur if gas leakage occurred and was present in the vacuum. The prevention of gas leakage also ensures that gas pressure may be maintained within interaction region 216 to ensure efficient generation of the optical output.

As will be discussed in greater detail below, device 200 may be manufactured such that optical path 214 and optical path 215 have high aspect ratios enabling microscale implementation of an optical path within device 200, and also manufactured to ensure consistent and accurate generation of such pathway features to ensure that they are sufficiently small to prevent a significant flow of gas from interaction region 216 to an external vacuum. In one example, optical path 214 and optical path 215 are manufactured with micrometer-level accuracy. For example, optical path 214 and optical path 215 may each have an effective diameter of 10 micrometers.

In various embodiments, an additive manufacturing process may be used to generate first housing portion 208 and second housing portion 212. For example, a three-dimensional metal printing technique may be used that enables the direct manufacturing of first housing portion 208 and second housing portion 212. In this way, first housing portion 208 and second housing portion 212 may be directly manufactured without the need for combination of subparts, and with consistent generation of micrometer-level features, such as optical pathways. In one example, one or more micro-direct metal laser sintering (micro-DMLS) may be used to manufacture first housing portion 208 and second housing portion 212. Accordingly, implementation of such metal deposition techniques may be used to ensure that optical path 214 and optical path 215 are sufficiently small to prevent substantial gas leakage through the optical paths. Moreover, implementation of such metal deposition techniques enables the creation of such a small width and high aspect ratio for a relatively long channel. In one example, the channel may have a high aspect ratio and a diameter of about 10 micrometers, and a length of about 10 millimeters. Moreover, the use of such techniques facilitates the use of additional type manufacturing materials that might not otherwise be machinable in such contexts, such as titanium alloys. Thus, in some embodiments, device 200 may be manufactured from a titanium alloy.

FIG. 3 illustrates another example of a device for gas pressure profile control, configured in accordance with some embodiments. As similarly discussed above, a gas pressure profile controller may be used to control a gas pressure profile during generation of an optical output via one or more techniques, such as excitation of a gas. Accordingly, a device, such as device 300, may be configured to implement such gas pressure profile control, thus maintaining a high-pressure gradient used for the generation of a optical output.

Accordingly, device 300 may include first housing portion 308 coupled to gas inlet 304, and second housing portion 312. As similarly discussed above, first housing portion 308 and second housing portion 312 may bound portions of an internal chamber, such as chamber 306. Moreover, interaction region 316 may be implemented between them and may receive an excitation light source via optical path 314, and may generate an optical output provided via optical path 315. As also discussed above, optical path 314 and optical path 315 may be manufactured to have high aspect ratios and diameters small enough to constrict gas flow from within a high-pressure region of interaction region 316 to an external vacuum downstream of optical path 315.

In various embodiments, device 300 further includes positioning system 318 which is configured to adjust a distance between sides of first housing portion 308 and second housing portion 312. More specifically, positioning system 318 may be configured to adjustably increase or decrease a distance between sides of first housing portion 308 and second housing portion 312, and in response to an input provided by an entity, such as a user. Accordingly, a width of interaction region 316 may be dynamically configurable based on one or more inputs received from a user. In some embodiments, positioning system 318 may include electromechanically controlled motors configured to change a distance between sides of first housing portion 308 and second housing portion 312 via threaded tracks on their respective bottoms and tops. The motors may be controlled via an input received from an external computer system. In some embodiments, device 300 may have a rectangular geometry, and sides of housing portions and positioning system 318 may have their edges sealed to prevent gas leakage despite movement of the housing portions.

In various embodiments, such configurability of the distance between sides of housing portions enables configurability of interaction region 316 to achieve a balance between efficiency of the optical output generation process and occurrence of reabsorption. For example, increasing a distance between sides of interaction region 316 may increase an efficiency of optical output generation. However, increasing the distance too far May introduce reabsorption within interaction region 316, thus decreasing efficiency of optical output. Accordingly, embodiments disclosed herein provide the ability to dynamically adjust the width of interaction region 316 to achieve a balance between optical output generation and reabsorption, and improve an overall efficiency of device 300.

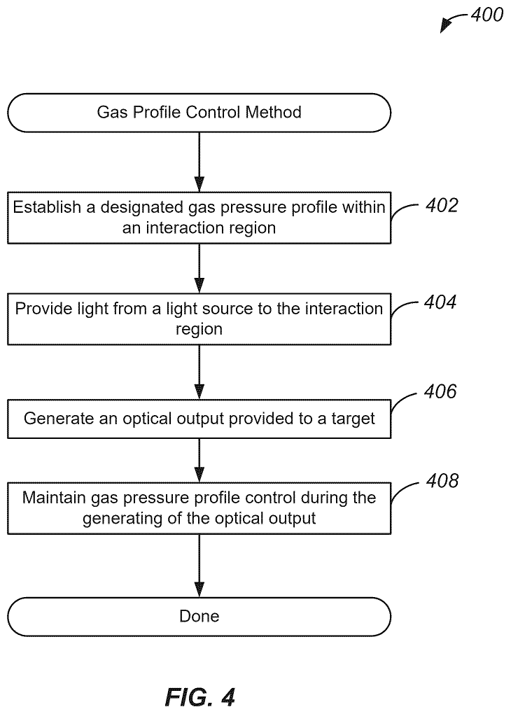

FIG. 4 illustrates an example of a method for gas pressure profile control, performed in accordance with some embodiments. As similarly discussed above, a gas pressure profile may be generated and controlled to maintain conditions for generation of an optical output via one or more techniques, such as excitation of the gas. Accordingly, a method, such as method 400, may be performed to implement such gas pressure profile control, thus maintaining a high-pressure gradient used for the generation of an optical output.

Method 400 may perform operation 402 during which a designated gas pressure profile may be established within an interaction region. In various embodiments, pressurized gas may be received from a gas source and may be provided to a gas pressure profile control device to pressurize an internal chamber. As similarly discussed above, the gas may enter an internal chamber of the gas pressure profile control device via a gas inlet, and may also be provided to an interaction region of the internal chamber. In this way, the internal chamber of the gas pressure profile control device may be pressurized with gas, and a gas pressure profile may be established within the device. As also discussed above, a region between the gas pressure profile control device and a target may be evacuated and maintained as a vacuum.

Method 400 may perform operation 404 during which light from a light source may be provided to the interaction region. In various embodiments, a light source may provide laser light that enters the gas pressure profile control device via an optical pathway and interacts with gas included in the interaction region. As similarly discussed above, the laser source and laser light may be configured to interact with the gas to cause excitation of the gas.

Method 400 may perform operation 406 during which an optical output may be generated and provided to a target. Accordingly, in response to receiving the laser light pulse, the gas within the interaction region may generate and emit light in response to the excitation. As similarly discussed above, such light may be generated via high-harmonic generation, and may emit light generated based on high harmonics of the received laser light pulse. Moreover, the generated light may be emitted via an additional optical pathway to a target for one or more purposes, such as mask defect detection.

Method 400 may perform operation 408 during which gas pressure profile control may be maintained during the generating of the optical output. As similarly discussed above, the optical pathways of the gas pressure profile control device may be configured to restrict gas flow from within the internal chamber to outside of the gas pressure profile control device. In this way, the optical pathways are configured to allow the passage of light into and out of the interaction region while restricting gas flow sufficiently to enable maintenance of the gas pressure profile and reduce leakage of the gas to the vacuum associated with the target.

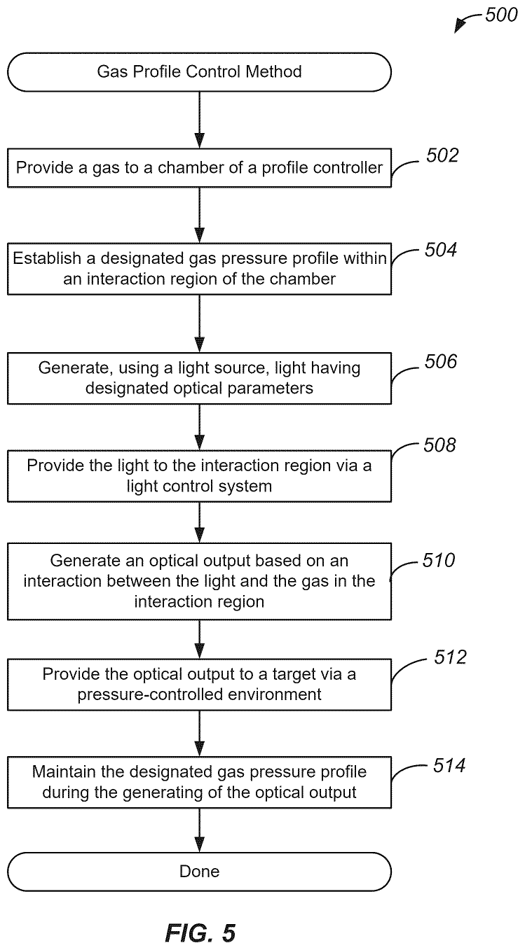

FIG. 5 illustrates another example of a method for gas pressure profile control, performed in accordance with some embodiments. As similarly discussed above, a gas pressure profile may be generated and controlled to maintain conditions for generation of an optical output via one or more techniques, such as excitation of the gas. Accordingly, a method, such as method 500, may be performed to implement such gas pressure profile control. Moreover, optical pathways may be configured to allow passage of light while maintaining such gas pressure profile control.

Method 500 may perform operation 502 during which a gas may be provided to a chamber of a profile controller. As similarly discussed above, gas may be received from a gas source and may be provided to a gas pressure profile controller. The gas may enter an internal chamber of the gas pressure profile controller via a gas inlet, and also be provided to an interaction region included in the internal chamber.

Method 500 may perform operation 504 during which a designated gas pressure profile may be established within an interaction region of the internal chamber. Accordingly, the gas may be provided to the internal chamber and the interaction region at a designated pressure, and may be provided consistently to maintain that pressure within the internal chamber and the interaction region. As similarly discussed above, control of the flow of gas may be maintained via a gas source and an associated computing device and/or computer system.

Method 500 may perform operation 506 during which light having designated optical parameters may be generated using a light source. As similarly discussed above, the light may be generated using a laser light source having a designated wavelength as well as one or more other parameters, such as a pulse frequency. In some embodiments, such light May have nanosecond or femtosecond pulses. However, any suitable pulse duration, pulse energy, and pulse repetition rate.

Method 500 may perform operation 508 during which the light may be provided to the interaction region via a light control system. As similarly discussed above, the laser light may enter the gas pressure profile controller via an optical pathway such that it may interact with gas included in the interaction region. Accordingly, a light controller may include one or more devices, such as a wave guide, configured to guide the laser light to the optical pathway. Thus, the laser light may be provided to the light controller, which may then provide the laser light to the interaction region.

Method 500 may perform operation 510 during which an optical output may be generated based on an interaction between the light and the gas in the interaction region. Accordingly, in response to receiving the laser light pulse, the gas within the interaction region may generate and emit light in response to the excitation. As similarly discussed above, such light may be generated via high-harmonic generation, and may be generated based on high harmonics of the received laser light pulse.

Method 500 may perform operation 512 during which the optical output may be provided to a target via a pressure-controlled environment. Accordingly, the light generated based on the high-harmonic generation within the interaction region may exit the gas pressure profile controller via an additional optical pathway to a target. As similarly discussed above, a vacuum may be maintained between the gas pressure profile controller and the target. Moreover, gas flow constriction provided by the additional optical pathway may prevent leakage of gas into the vacuum and reduce reabsorption that would otherwise occur.

Method 500 may perform operation 514 during which the designated gas pressure profile may be maintained during the generating of the optical output. As similarly discussed above, the optical pathways of the gas pressure profile control device may be configured to restrict gas flow from within the internal chamber to outside of the gas pressure profile control device. In this way, the optical pathways are configured to allow the passage of light into and out of the interaction region while restricting gas flow sufficiently to enable maintenance of the gas pressure profile and reduce leakage of the gas to the vacuum associated with the target.

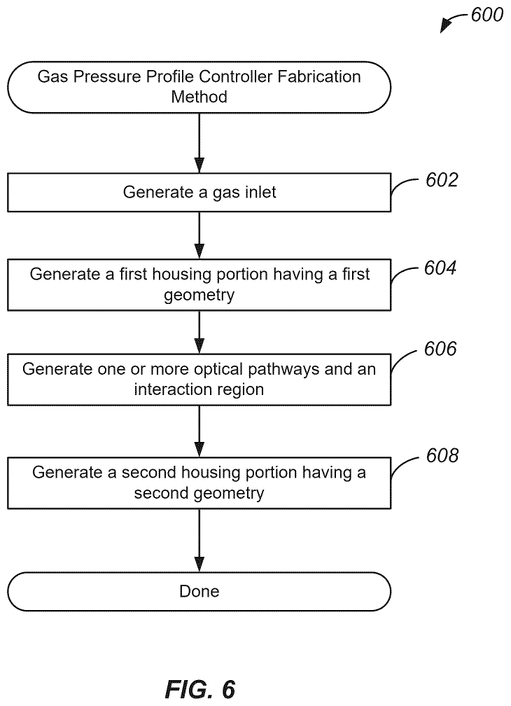

FIG. 6 illustrates an example of an additional method for gas pressure profile controller fabrication, performed in accordance with some embodiments. As similarly discussed above, one or more metal deposition techniques may be used to generate a gas pressure profile controller. More specifically, such metal deposition techniques may be used to achieve high aspect ratios for optical pathways that allow them to be fabricated smaller and more precisely, thus enabling them to achieve gas flow constriction for establishing and maintaining gas pressure profiles as discussed above.

Method 600 may perform operation 602 during which a gas inlet may be generated. Accordingly, a three dimensional additive manufacturing process, such as micro-DMLS, May be used to generate a first portion of the gas pressure profile controller. In various embodiments, the first portion includes an end of the gas pressure profile controller configured to be coupled to a gas source, and that may include a gas inlet as discussed above, with reference to FIG. 2.

Method 600 may perform operation 604 during which a first housing portion may be generated. The first housing portion may also be generated using the three-dimensional additive manufacturing process. Moreover, the first housing portion may have a first geometry that is conical, and has a relatively high taper to reduce an overall size of the gas pressure profile controller. Accordingly, in some embodiments, use of the three-dimensional additive manufacturing process enables implementation of a high aspect ratio of the conical geometry of the first housing portion that allows a reduction in an overall size of gas pressure profile controller.

Method 600 may perform operation 606 during which one or more optical pathways and an interaction region may be generated. In various embodiments, the optical pathways may be generated by creating high aspect ratio channels in a top portion of the first housing portion. As similarly discussed above, the three-dimensional additive manufacturing process may allow precise deposition of metal to allow the optical pathways to be generated with micrometer-level accuracy, and high aspect ratio channel walls that result in a precise and relatively small hole that allows passage of light but restricts the flow of gas. Moreover, a through hole at the end of the conical portion may also be generated during generation of the first housing portion to provide an interaction region.

Method 600 may perform operation 608 during which a second housing portion having a second geometry may be generated. In various embodiments, the second housing portion has a geometry that mirrors the first housing portion. Accordingly, the three-dimensional additive manufacturing process may continue adding material to generate the second housing portion that may also have a conical geometry and a high aspect ratio of such a conical geometry. Moreover, the second housing portion may be similarly configured to include corresponding parts of the optical pathways and the interaction region.

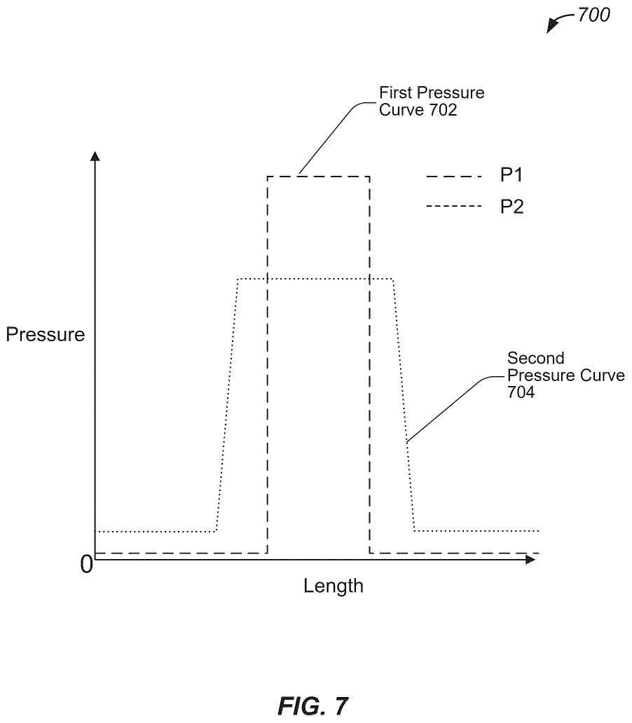

FIG. 7 illustrates an example of a diagram of gas pressure profiles, configured in accordance with some embodiments. Accordingly, diagram 700 illustrates first pressure curve 702 and second pressure curve 704 representing pressures along a length of an optical path. More specifically, the x-axis may represent length along the pathway as light is generated by a light source, provided to an interaction region of a gas pressure profile controller, and output as an optical output. The y-axis may represent pressure. Accordingly, as shown in diagram 700, pressure may initially be relatively low, then be relatively high within gas pressure profile controller, and then relatively low again between the gas pressure profile controller and a target. Moreover, second pressure curve 704 illustrates some ambient pressure outside a gas pressure profile controller, a transition to high pressure maintained within the gas pressure profile controller, and an additional transition to an ambient pressure outside the gas pressure profile controller and adjacent to the target.

In various embodiments, first pressure curve 702 illustrates a pressure curve for embodiments using a gas pressure profile controller as disclosed herein. More specifically, first pressure curve 702 illustrates a near vacuum outside the gas pressure profile controller, a near instantaneous transition to high pressure maintained within the gas pressure profile controller, and a near instantaneous transition to a near vacuum outside the gas pressure profile controller and adjacent to the target. Accordingly, first pressure curve 702 illustrates how a lower pressure and near vacuum is maintained outside of the gas pressure profile controller when compared to other devices not able to achieve such gas pressure profile control as disclosed herein. Moreover, the pressure within the gas pressure profile controller is higher, and the transitions between low and high pressure regions is more tightly controlled. As similarly discussed above, such control over the transitions and maintenance of a near vacuum outside the gas pressure profile controller reduces reabsorption and increases an overall efficacy and efficiency of the generation of the optical output.

Although the foregoing concepts have been described in some detail for purposes of clarity of understanding, it will be apparent that certain changes and modifications may be practiced within the scope of the appended claims. It should be noted that there are many alternative ways of implementing processes, systems, and apparatuses. Accordingly, the present embodiments are to be considered illustrative and not restrictive. claims

1. A system comprising:
a light source configured to generate laser light;
a gas pressure profile controller comprising:
a first housing portion;
a second housing portion coupled to the first housing portion, wherein the first housing portion and the second housing portion include an internal chamber, wherein the internal chamber includes an interaction region;
a first optical path configured to receive the laser light;
a second optical path configured to transmit an optical output generated, at least in part, based on an interaction between the laser light and a gas, the second optical path being further configured to constrict a flow of gas from the interaction region; and
a gas source configured to provide a gas to the gas pressure profile controller.

2. The system of claim 1, wherein the optical output is generated via high harmonic generation of light based on an interaction between the laser light and the gas within the interaction region.

3. The system of claim 2, wherein the optical output includes extreme ultraviolet light.

4. The system of claim 1, wherein the first housing portion and the second housing portion have conical geometries.

5. The system of claim 1, wherein the first housing portion and the second housing portion are generated via a three-dimensional additive manufacturing process.

6. The system of claim 1, wherein the second optical path has an aperture that is less than 50 micrometers.

7. The system of claim 1 further comprising:
a light controller configured to focus the laser light to the first optical path.

8. The system of claim 1, wherein a width of the interaction region is adjustable.

9. The system of claim 8, wherein the width of the interaction region is dynamically adjustable in response to a user input.

10. A device comprising:
a first housing portion including a first portion of an internal chamber configured to receive gas from a gas source;
a second housing portion coupled to the first housing portion wherein the first housing portion and the second housing portion include an internal chamber configured to receive gas from a gas source, wherein the internal chamber includes an interaction region;
a first optical path configured to receive laser light from a light source and further configured to constrict a flow of gas from the interaction region; and
a second optical path configured to transmit an optical output generated based, at least in part, on an interaction between the laser light and a gas, the second optical path being further configured to constrict a flow of gas from the interaction region.

11. The device of claim 10, wherein the optical output is generated via high harmonic generation of light based on an interaction between the laser light and the gas within the interaction region.

12. The device of claim 11, wherein the optical output includes extreme ultraviolet light.

13. The device of claim 10, wherein the first housing portion and the second housing portion have conical geometries.

14. The device of claim 10, wherein the first housing portion and the second housing portion are generated via a three-dimensional additive manufacturing process.

15. The device of claim 10, wherein a width of the interaction region is adjustable.

16. A method comprising:
establishing a designated gas pressure profile within an interaction region of a gas pressure profile controller, the gas pressure profile controller comprising a first housing portion and a second housing portion coupled to the first housing portion via the interaction region;
providing light from a light source to the interaction region via a first optical path;
generating an optical output via a second optical path and based, at least in part, on an interaction between a gas within the interaction region and the light; and
maintaining the designated gas pressure profile during the generating of the optical output.

17. The method of claim 16, wherein the optical output is generated via high harmonic generation of light based on the interaction between the light and the gas within the interaction region.

18. The method of claim 16, wherein the first housing portion and the second housing portion have conical geometries.

19. The method of claim 16, wherein the first housing portion and the second housing portion are generated via a three-dimensional additive manufacturing process.

20. The method of claim 16, wherein the second optical path has an aperture that is less than 50 micrometers.
